(19) United States
(12) Patent Application Publication
(10) Pub. No.: US 2022/0005423 A1
(43) Pub. Date: Jan. 6, 2022

(54) DRIVING CIRCUIT AND RELATED DISPLAY PANEL AND DISPLAY MODULE

(71) Applicant: WUHAN CHINA STAR OPTOELECTRONICS SEMICONDUCTOR DISPLAY TECHNOLOGY CO., LTD., Wuhan (CN)

(72) Inventors: Xiaofeng LIU, Wuhan (CN); Jing YUAN, Wuhan (CN)

(73) Assignee: WUHAN CHINA STAR OPTOELECTRONICS SEMICONDUCTOR DISPLAY TECHNOLOGY CO., LTD., Wuhan (CN)

(21) Appl. No.: 16/963,848

(22) PCT Filed: Jan. 9, 2020
(86) PCT No.: PCT/CN2020/071138

§ 371 Date: Jul. 22, 2020

(30) Foreign Application Priority Data
Sep. 25, 2019 (CN) 201910911410.4

(51) Int. Cl. G09G 3/36

(52) U.S. Cl. CPC G09G 3/36; G09G 2310/0289; G09G 2300/0814

(57) ABSTRACT

A driving circuit and a display panel are provided. The driving circuit includes a first processing module configured to process a working voltage detected by an XAO module, a second processing module configured to process an output voltage of a level shifter, and a calculation module electrically connected to the first processing module and the second processing module.

### CROSS REFERENCE

This application claims the priority of Chinese Patent Application No. 201910911410.4, entitled “DRIVING CIRCUIT AND RELATED DISPLAY PANEL AND DISPLAY MODULE”, filed on Sep. 25, 2019, the disclosure of which is incorporated herein by reference in its entirety.

### FIELD OF THE INVENTION

The present invention relates to a display technique, and more particularly, to a driving circuit and a related display panel and display module.

### BACKGROUND OF THE INVENTION

In recent years, liquid crystal displays (LCD) have been widely used in all kinds of electronic devices, such as cell phone, laptop and TV due to its thinness.

When the display device is turned off, the charges in the pixels need to be released to prevent from flickers or ghost images caused by the charges. Conventionally, an XAO module is used to output an XAO signal to the driving circuit to turn on all the columns to release/neutralize the residual charges in the pixels.

However, the XAO module is easily influenced by other signals such that the voltage detected by the XAO module might be interfered. This makes it difficult for the level shifter to determine the detected voltage detected by the XAO module. Therefore, the display panel may not correctly display the images.

Therefore, a novel driving circuit is needed to solve the above-mentioned issue.

### SUMMARY OF THE INVENTION

One objective of an embodiment of the present invention is to provide a driving circuit and a related display panel and display module, to solve the above-mentioned issue of the abnormal detected voltage detected by the XAO module, which may result in incorrect display results of the display panel.

According to an embodiment of the present invention, a driving circuit is disclosed. The driving circuit comprises: a first processing module, configured to process a working voltage detected by an XAO module; a second processing module, configured to process an output voltage of a level shifter; and a calculation module, electrically connected to the first processing module and the second processing module; wherein when the working voltage detected by the XAO module is lower than a first threshold voltage and the output voltage of the level shifter is higher than a second threshold voltage, the driving circuit deactivates a detection function of the XAO module; otherwise, the driving circuit activates the detection function of the XAO module.

In the driving circuit, the first processing module comprises: a first detection unit, configured to detect the working voltage detected by the XAO module; a first input unit, configured to provide the first threshold voltage; a first comparator, configured to compare the working voltage with the first threshold voltage; and a first output unit, configured to output a calculation result of the first comparator.

In the driving circuit, the first processing module further comprises: a first converting module, configured to convert the calculation result of the first comparator into a digital signal; wherein when the working voltage is lower than the first threshold voltage, the first converting module outputs a logic 1; wherein when the working voltage is higher than the first threshold voltage, the first converting module outputs a logic 0.

In the driving circuit, the second processing module comprises: a second detection unit, configured to detect the output voltage of the level shifter; a second input unit, configured to provide the second threshold voltage; a second comparator, configured to compare the output voltage with the second threshold voltage; and a second output unit, configured to output a calculation result of the second comparator.

In the driving circuit, the second processing module further comprises: a second converting module, configured to convert the calculation result of the second comparator into a digital signal; wherein when the output voltage is higher than the second threshold voltage, the second converting module outputs a logic 1; wherein when the output voltage is lower than the second threshold voltage, the second converting module outputs a logic 0.

In the driving circuit, the calculation module comprises: a first calculation unit, comprising a first logic gate, configured to output a first calculation result according to calculation results outputted from a first output unit and a second output unit; and a second calculation unit, comprising a second logic gate, configured to output a second calculation result according to the calculation results outputted from the first output unit and the second output unit; and; wherein the first logic gate and the second logic gate are different.

In the driving circuit, the first logic gate comprises an Exclusive-OR (XOR) gate and the second logic gate comprises an AND gate; wherein when the first calculation result corresponds to a logic 0 and the second calculation result corresponds to a logic 1, the driving circuit deactivates the detection function of the XAO module.

According to another embodiment of the present invention, a display panel is disclosed. The display panel comprises a driving circuit. The driving circuit comprises: a first processing module, configured to process a working voltage detected by an XAO module; a second processing module, configured to process an output voltage of a level shifter; and a calculation module, electrically connected to the first processing module and the second processing module; wherein when the working voltage detected by the XAO module is lower than a first threshold voltage and the output voltage of the level shifter is higher than a second threshold voltage, the driving circuit deactivates a detection function of the XAO module; otherwise, the driving circuit activates the detection function of the XAO module.

In the display panel, the first processing module comprises: a first detection unit, configured to detect the working voltage detected by the XAO module; a first input unit, configured to provide the first threshold voltage; a first comparator, configured to compare the working voltage with the first threshold voltage; and a first output unit, configured to output a calculation result of the first comparator.

In the display panel, the first processing module further comprises: a first converting module, configured to convert the calculation result of the first comparator into a digital signal; wherein when the working voltage is lower than the first threshold voltage, the first converting module outputs a logic 1; wherein when the working voltage is higher than the first threshold voltage, the first converting module outputs a logic 0.

In the display panel, the second processing module comprises: a second detection unit, configured to detect the output voltage of the level shifter; a second input unit, configured to provide the second threshold voltage; a second comparator, configured to compare the output voltage with the second threshold voltage; and a second output unit, configured to output a calculation result of the second comparator.

In the display panel, the second processing module further comprises: a second converting module, configured to convert the calculation result of the second comparator into a digital signal; wherein when the output voltage is higher than the second threshold voltage, the second converting module outputs a logic 1; wherein when the output voltage is lower than the second threshold voltage, the second converting module outputs a logic 0.

In the display panel, the calculation module comprises: a first calculation unit, comprising a first logic gate, configured to output a first calculation result according to calculation results outputted from a first output unit and a second output unit; and a second calculation unit, comprising a second logic gate, configured to output a second calculation result according to the calculation results outputted from the first output unit and the second output unit; and; wherein the first logic gate and the second logic gate are different.

In the display panel, the first logic gate comprises an Exclusive-OR (XOR) gate and the second logic gate comprises an AND gate; wherein when the first calculation result corresponds to a logic 0 and the second calculation result corresponds to a logic 1, the driving circuit deactivates the detection function of the XAO module.

In contrast to the conventional art, an embodiment of the present invention detects the detected working voltage of the XAO module and the output voltage of the level shifter. When the working voltage detected by the XAO module is lower than the first threshold voltage and the output voltage of the level shifter is higher than the second threshold voltage, the detection function of the XAO module is deactivated. This could solve the above-mentioned issues of the level shifter which may not correctly obtain the detected voltage detected by the XAO module when the XAO module is interfered by other signals. This ensures that the display device could correctly display images.

### BRIEF DESCRIPTION OF THE DRAWINGS

FIG. 1 is a diagram of a structure of a driving circuit according to an embodiment of the present invention.

FIG. 2 is a diagram of a structure of a driving circuit according to another embodiment of the present invention.

FIG. 3 is a diagram of a structure of a driving circuit according to another embodiment of the present invention.

### DETAILED DESCRIPTION OF PREFERRED EMBODIMENTS

Embodiments of the present application are illustrated in detail in the accompanying drawings, in which like or similar reference numerals refer to like or similar elements or elements having the same or similar functions throughout the specification. The embodiments described below with reference to the accompanying drawings are exemplary and are intended to be illustrative of the present application, and are not to be construed as limiting the scope of the present application.

As previously mentioned, conventionally, the XAO module may be easily influenced by other signals such that the detected voltage detected by the XAO module is interfered as well. Thus, the level shifter may not correctly determine the detected voltage detected by the XAO module. Then, the display device may not correctly display images. In order to solve this issue, an embodiment of the present invention provides a driving circuit.

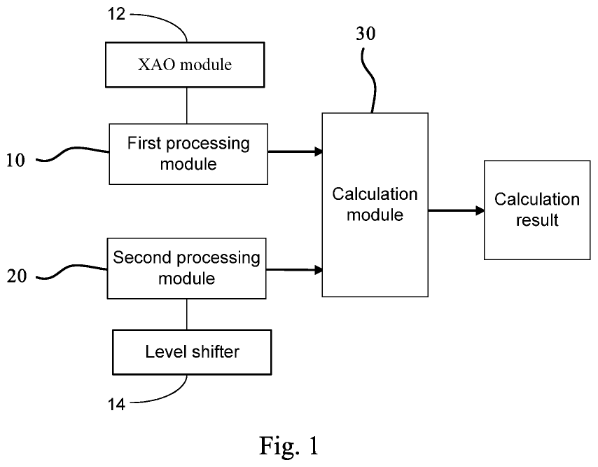

Please refer to FIG. 1. The driving circuit 100 comprises a first processing module 10, a second processing module 20 and a calculation module 30. The first processing module 10 is electrically connected to the calculation module 30. The second processing module 20 is electrically connected to the calculation module 30.

The first processing module is used to process a working voltage detected by an XAO module. The second processing module is used to process an output voltage of a level shifter. When the working voltage detected by the XAO module is lower than a first threshold voltage and the output voltage of the level shifter is higher than a second threshold voltage, the driving circuit 100 deactivates a detection function of the XAO module. Otherwise, the driving circuit 100 activates the detection function of the XAO module.

This embodiment detects the detected working voltage of the XAO module and the output voltage of the level shifter. When the working voltage detected by the XAO module is lower than the first threshold voltage and the output voltage of the level shifter is higher than the second threshold voltage, the detection function of the XAO module is deactivated. This could solve the above-mentioned issues of the level shifter which may not correctly obtain the detected voltage detected by the XAO module when the XAO module is interfered by other signals. This also ensures that the display device could correctly display images.

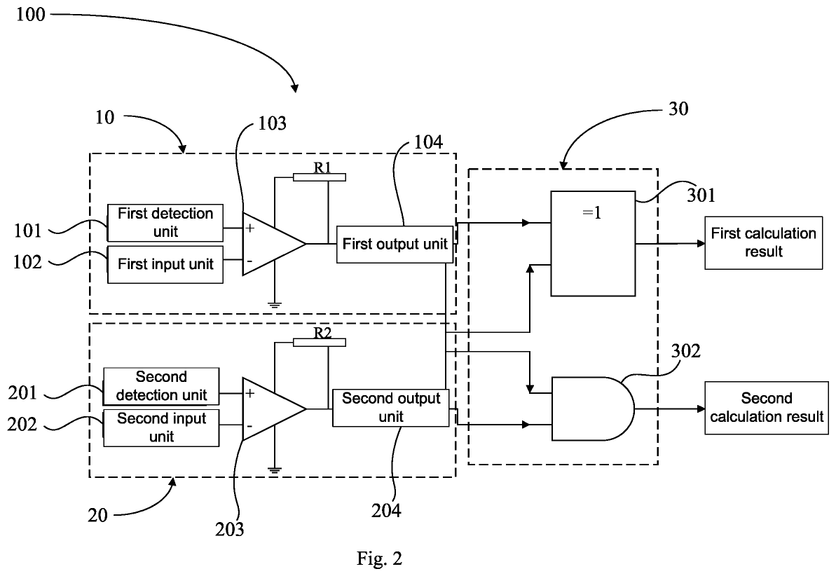

Please refer to FIG. 2. The first processing module 10 comprises the first detection unit 101, the first input unit 102, the first comparator 103 and the first output unit 104.

The first detection unit 101 is used to detect the working voltage detected by the XAO module. The first input unit 102 is used to provide the first threshold voltage. The first comparator 103 is used to compare the working voltage detected by the XAO module with the first threshold voltage. The first output unit 104 is used to output the calculation result of the comparator 103.

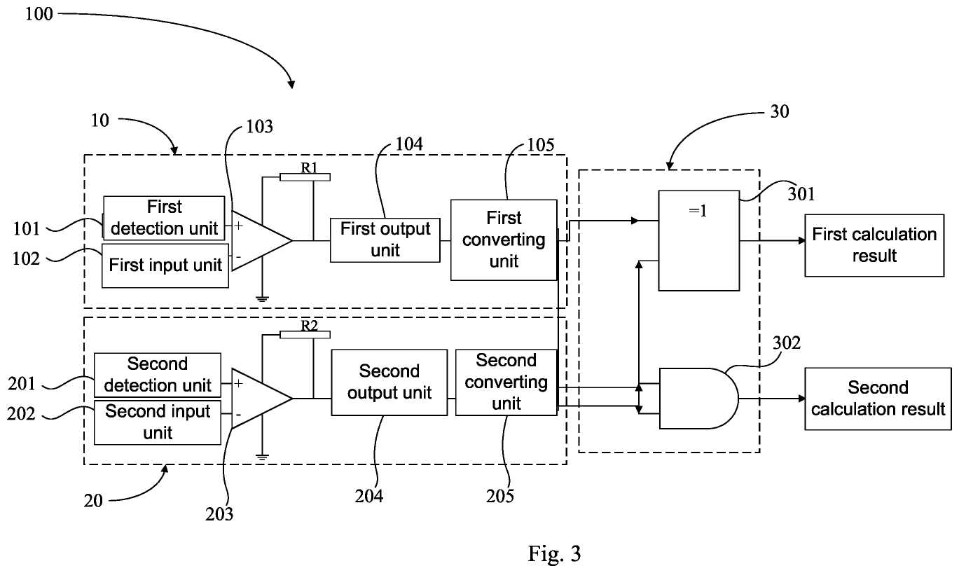

Please refer to FIG. 3. The first processing module 10 further comprises a first converting unit 105, which is used to convert the calculation result of the first comparator 103 into a digital signal.

When the working voltage is lower than the first threshold voltage, the first converting module outputs a logic 1. When the working voltage is higher than the first threshold voltage, the first converting module outputs a logic 0.

In this embodiment, the first threshold voltage is provided by the first input unit 102. Furthermore, the value of the first threshold voltage could be set according to the actual implementations. For example, the first threshold voltage could be 1.2V in this embodiment. When the working voltage of the display device detected by the XAO module is lower than 1.2V (that is, the detection function of the XAO module is activated), the first converting unit 105 outputs a digital signal corresponding to the logic 1. When the working voltage of the display device detected by the XAO module is higher than 1.2V (that is, the detection function of the XAO module is deactivated), the first converting unit 105 outputs a digital signal corresponding to the logic 0.

Please refer to FIG. 2. The second processing module 20 comprises a second detection unit 201, a second input unit 202, a second comparator 203 and a second output unit 204.

The second detection unit 201 is used to detect the output voltage of the level shifter. The second input unit 202 is used to provide the second threshold voltage. The second comparator 203 is used to compare the output voltage of the level shifter with the second threshold voltage. The second output unit 204 is used to output the calculation result of the second comparator 203.

Please refer to FIG. 3. The second processing module 20 further comprises a second converting module 205. The second converting module 205 is used to convert the calculation result of the second comparator into a digital signal.

When the output voltage is higher than the second threshold voltage, the second converting module outputs a logic 1. When the output voltage is lower than the second threshold voltage, the second converting module outputs a logic 0.

In this embodiment, the second threshold voltage is provided by the second input unit 202. Furthermore, the value of the second threshold voltage could be set according to the actual implementations. Here, the voltage detected by the second detection unit 201 is a low voltage level Vgl of the level shifter. When the XAO module is activated, all of the low voltage levels Vgl are pulled-up to a high voltage level Vgh. Here, the value Vgl is a comparative value. This means that the value Vgl is lower than the second threshold voltage. After the voltage level is pulled up, the voltage level Vgh is higher than the second threshold voltage.

When the output voltage of the level shifter is higher than the second threshold voltage, the XAO module is activated. The output voltage Vgl of the level shifter is pulled up to the high voltage level Vgh and thus the second converting unit 205 outputs a digital signal corresponding to the logic 1. When the XAO module is deactivated, the output voltage Vgl of the level shifter is not pulled up to the voltage level Vgh and thus the second converting unit 205 outputs a digital signal corresponding to the logic 1.

Please refer to FIG. 2 and FIG. 3. The calculation module 30 comprises: a first calculation unit 301 and a second calculation unit 302. The first calculation unit 301 comprises a first logic gate. The first logic gate is used to output a first calculation result according to the calculation result outputted from the first output unit 104 and the calculation result outputted from the second output unit 204. The second calculation unit comprises a second logic gate. The second logic gate is used to output a second calculation result according to the calculation result outputted from the first output unit 104 and the calculation result outputted from the second output unit 204. In this embodiment, the first logic gate and the second logic gate are different.

In this embodiment, the first logic gate comprises an Exclusive-OR (XOR) gate and the second logic gate comprises an AND gate. For example, when the first converting unit 105 outputs the logic 0 and the second converting unit 205 outputs the logic 0, the first calculation result is logic 0 and the second calculation result is logic 0 according to the principles of the XOR gate and the AND gate.

When the first converting unit 105 outputs the logic 1 and the second converting unit 205 outputs the logic 0, the first calculation result is logic 1 and the second calculation result is logic 0 according to the principles of the XOR gate and the AND gate.

When the first converting unit 105 outputs the logic 0 and the second converting unit 205 outputs the logic 1, the first calculation result is logic 1 and the second calculation result is logic 0 according to the principles of the XOR gate and the AND gate.

When the first converting unit 105 outputs the logic 1 and the second converting unit 205 outputs the logic 1, the first calculation result is logic 0 and the second calculation result is logic 1 according to the principles of the XOR gate and the AND gate.

The four above-mentioned embodiments are as below:

| | |
|---|---|
| Input | Output |

| First | Second | First | Second |
|---|---|---|---|
| converting | converting | calculation | calculation |
| unit | unit | unit | unit |
| 0 | 0 | 0 | 0 |
| 1 | 0 | 1 | 0 |
| 0 | 1 | 1 | 0 |
| 1 | 1 | 0 | 1 |

In the first embodiment, when the first converting unit outputs the logic 0 and the working voltage of the display device detected by the XAO module is higher than 1.2V, it means that the detection function of the XAO module is in the deactivation condition. When the second converting unit 205 outputs the logic 0 and the output voltage of the level shifter is lower than the second threshold voltage, it means that the XAO function is not activated and the output voltage Vgl of the level shifter is not pulled up to the high voltage level Vgh.

In this embodiment, the detection function of the XAO module is not activated and the external signals cannot influence the XAO module.

In the second embodiment, when the first converting unit 105 outputs the logic 1 and the working voltage of the display device detected by the XAO module is lower than 1.2V, it means that the detection function of the XAO module is activated. When the second converting unit 205 outputs the logic 0 and the output voltage of the level shifter is lower than the second threshold voltage, it means that the XAO function is not activated and the output voltage Vgl of the level shifter is not pulled up to the high voltage level Vgh.

In this embodiment, although the detection function of the XAO module is activated, the voltage level of the level shifter is not pulled to a high voltage level and thus remains stable. Therefore, the XAO module does not need to be deactivated.

In the third embodiment, when the first converting unit 105 outputs the logic 0 and the working voltage of the display device detected by the XAO module is higher than 1.2V, it means that the detection function of the XAO module is deactivated. When the second converting unit 205 outputs the logic 1 and the output voltage of the level shifter is higher than the second threshold voltage, it means that the XAO module is activated and the output voltage Vgl of the level shifter is pulled up to the high voltage level Vgh.

In this embodiment, because the detection function of the XAO module is deactivated and the output voltage Vgl of the level shifter is pulled to the high voltage level Vgh, the raise of the output voltage of the level shifter is not related to the XAO module. Therefore, there is no need to deactivate the XAO module.

In the fourth embodiment, when the first converting unit 105 outputs the logic 1 and the working voltage of the display device detected by the XAO module is lower than 1.2V, it means that the detection function of the XAO module is activated. When the second converting unit 205 outputs the logic 1 and the output voltage of the level shifter is higher than the second threshold voltage, it means that the XAO module is activated and the output voltage Vgl of the level shifter is pulled up to the high voltage level Vgh.

In this embodiment, the detection function of the XAO module is activated and the output voltage Vgl of the level shifter is pulled to the high voltage level Vgh. Therefore, the driving circuit could determine that the raise of the output voltage of the level shifter is due to the XAO module. At this stage, when the XAO module is activated, the detection voltage of the XAO module varies (raises) in a certain amount and cause the output voltage Vgl of the level shifter to raise correspondingly due to the XAO module. Therefore, in order to ensure that the display device could correctly display images, the XAO module should be deactivated at this stage.

In addition, a display panel is disclosed. The display panel comprises the above-mentioned driving circuit 100.

Please refer to FIG. 1. The driving circuit 100 comprises a first processing module 10, a second processing module 20 and a calculation module 30. The first processing module 10 is electrically connected to the calculation module 30. The second processing module 20 is electrically connected to the calculation module 30.

The first processing module is used to process a working voltage detected by an XAO module. The second processing module is used to process an output voltage of a level shifter. When the working voltage detected by the XAO module is lower than a first threshold voltage and the output voltage of the level shifter is higher than a second threshold voltage, the driving circuit 100 deactivates a detection function of the XAO module. Otherwise, the driving circuit 100 activates the detection function of the XAO module.

Here, the operations of the display panel are similar to the operations of the driving circuit and further illustrations are omitted for simplicity.

Furthermore, a display module is disclosed. The display module comprises the above-mentioned display panel. Since the operations of the display module are similar to the operations of the display panel, further illustrations are omitted for simplicity.

According to an embodiment of the present invention, a driving circuit and a related display panel and display module are disclosed. The driving circuit comprises a first processing module, a second processing module and a calculation module. The first processing module is electrically connected to the calculation module. The second processing module is electrically connected to the calculation module. The first processing module is used to process a working voltage detected by an XAO module. The second processing module is used to process an output voltage of a level shifter. When the working voltage detected by the XAO module is lower than a first threshold voltage and the output voltage of the level shifter is higher than a second threshold voltage, the driving circuit 100 deactivates a detection function of the XAO module. This could solve the technical issues of the conventional level shifter which may not correctly obtain the detected voltage detected by the conventional XAO module when the XAO module is interfered by other signals. This also ensures that the display device could correctly display images.

Above are embodiments of the present invention, which does not limit the scope of the present invention. Any modifications, equivalent replacements or improvements within the spirit and principles of the embodiment described above should be covered by the protected scope of the invention.

1. A driving circuit, comprising:
a first processing module, configured to process a working voltage detected by an XAO module;
a second processing module, configured to process an output voltage of a level shifter; and
a calculation module, electrically connected to the first processing module and the second processing module;
wherein when the working voltage detected by the XAO module is lower than a first threshold voltage and the output voltage of the level shifter is higher than a second threshold voltage, the driving circuit deactivates a detection function of the XAO module;
otherwise, the driving circuit activates the detection function of the XAO module.

2. The driving circuit of claim 1, wherein the first processing module comprises:
a first detection unit, configured to detect the working voltage detected by the XAO module;
a first input unit, configured to provide the first threshold voltage;
a first comparator, configured to compare the working voltage with the first threshold voltage; and
a first output unit, configured to output a calculation result of the first comparator.

3. The driving circuit of claim 2, wherein the first processing module further comprises:
a first converting module, configured to convert the calculation result of the first comparator into a digital signal;
wherein when the working voltage is lower than the first threshold voltage, the first converting module outputs a logic 1;
wherein when the working voltage is higher than the first threshold voltage, the first converting module outputs a logic 0.

4. The driving circuit of claim 1, wherein the second processing module comprises:
a second detection unit, configured to detect the output voltage of the level shifter;
a second input unit, configured to provide the second threshold voltage;
a second comparator, configured to compare the output voltage with the second threshold voltage; and
a second output unit, configured to output a calculation result of the second comparator.

5. The driving circuit of claim 4, wherein the second processing module further comprises:
a second converting module, configured to convert the calculation result of the second comparator into a digital signal;
wherein when the output voltage is higher than the second threshold voltage, the second converting module outputs a logic 1;
wherein when the output voltage is lower than the second threshold voltage, the second converting module outputs a logic 0.

6. The driving circuit of claim 1, wherein the calculation module comprises:
a first calculation unit, comprising:
a first logic gate, configured to output a first calculation result according to calculation results outputted from a first output unit and a second output unit; and
a second calculation unit, comprising:
a second logic gate, configured to output a second calculation result according to the calculation results outputted from the first output unit and the second output unit; and;
wherein the first logic gate and the second logic gate are different.

7. The driving circuit of claim 6, wherein the first logic gate comprises an Exclusive-OR (XOR) gate and the second logic gate comprises an AND gate;
wherein when the first calculation result corresponds to a logic 0 and the second calculation result corresponds to a logic 1, the driving circuit deactivates the detection function of the XAO module.

8. A display panel comprising a driving circuit, the driving circuit comprising:
a first processing module, configured to process a working voltage detected by an XAO module;
a second processing module, configured to process an output voltage of a level shifter; and
a calculation module, electrically connected to the first processing module and the second processing module;
wherein when the working voltage detected by the XAO module is lower than a first threshold voltage and the output voltage of the level shifter is higher than a second threshold voltage, the driving circuit deactivates a detection function of the XAO module; otherwise, the driving circuit activates the detection function of the XAO module.

9. The display panel of claim 8, wherein the first processing module comprises:
a first detection unit, configured to detect the working voltage detected by the XAO module;
a first input unit, configured to provide the first threshold voltage;
a first comparator, configured to compare the working voltage with the first threshold voltage; and
a first output unit, configured to output a calculation result of the first comparator.

10. The display panel of claim 9, wherein the first processing module further comprises:
a first converting module, configured to convert the calculation result of the first comparator into a digital signal;
wherein when the working voltage is lower than the first threshold voltage, the first converting module outputs a logic 1;
wherein when the working voltage is higher than the first threshold voltage, the first converting module outputs a logic 0.

11. The display panel of claim 8, wherein the second processing module comprises:
a second detection unit, configured to detect the output voltage of the level shifter;
a second input unit, configured to provide the second threshold voltage;
a second comparator, configured to compare the output voltage with the second threshold voltage; and
a second output unit, configured to output a calculation result of the second comparator.

12. The display panel of claim 11, wherein the second processing module further comprises:
a second converting module, configured to convert the calculation result of the second comparator into a digital signal;
wherein when the output voltage is higher than the second threshold voltage, the second converting module outputs a logic 1;
wherein when the output voltage is lower than the second threshold voltage, the second converting module outputs a logic 0.

13. The display panel of claim 8, wherein the calculation module comprises:
a first calculation unit, comprising:
a first logic gate, configured to output a first calculation result according to calculation results outputted from a first output unit and a second output unit; and
a second calculation unit, comprising:
a second logic gate, configured to output a second calculation result according to the calculation results outputted from the first output unit and the second output unit; and;
wherein the first logic gate and the second logic gate are different.

14. The display panel of claim 13, wherein the first logic gate comprises an Exclusive-OR (XOR) gate and the second logic gate comprises an AND gate;
wherein when the first calculation result corresponds to a logic 0 and the second calculation result corresponds to a logic 1, the driving circuit deactivates the detection function of the XAO module.

15. A display module comprising a display panel and a driving circuit, the driving circuit comprising:
a first processing module, configured to process a working voltage detected by an XAO module;
a second processing module, configured to process an output voltage of a level shifter; and
a calculation module, electrically connected to the first processing module and the second processing module;
wherein when the working voltage detected by the XAO module is lower than a first threshold voltage and the output voltage of the level shifter is higher than a second threshold voltage, the driving circuit deactivates a detection function of the XAO module;
otherwise, the driving circuit activates the detection function of the XAO module.

16. The display module of claim 15, wherein the first processing module comprises:
a first detection unit, configured to detect the working voltage detected by the XAO module;
a first input unit, configured to provide the first threshold voltage;
a first comparator, configured to compare the working voltage with the first threshold voltage; and
a first output unit, configured to output a calculation result of the first comparator.

17. The display module of claim 16, wherein the first processing module further comprises:
a first converting module, configured to convert the calculation result of the first comparator into a digital signal;
wherein when the working voltage is lower than the first threshold voltage, the first converting module outputs a logic 1;
wherein when the working voltage is higher than the first threshold voltage, the first converting module outputs a logic 0.

18. The display module of claim 15, wherein the second processing module comprises:
a second detection unit, configured to detect the output voltage of the level shifter;
a second input unit, configured to provide the second threshold voltage;
a second comparator, configured to compare the output voltage with the second threshold voltage; and
a second output unit, configured to output a calculation result of the second comparator.

19. The display module of claim 18, wherein the second processing module further comprises:
a second converting module, configured to convert the calculation result of the second comparator into a digital signal;
wherein when the output voltage is higher than the second threshold voltage, the second converting module outputs a logic 1;
wherein when the output voltage is lower than the second threshold voltage, the second converting module outputs a logic 0.

20. The display module of claim 15, wherein the calculation module comprises:
a first calculation unit, comprising:
a first logic gate, configured to output a first calculation result according to calculation results outputted from a first output unit and a second output unit; and
a second calculation unit, comprising:
a second logic gate, configured to output a second calculation result according to the calculation results outputted from the first output unit and the second output unit; and;
wherein the first logic gate and the second logic gate are different.
